(19) United States
(12) Patent Application Publication
(10) Pub. No.: US 2025/0104560 A1
(43) Pub. Date: Mar. 27, 2025

(54) Signal device for creating a signal produced by light in traffic

(71) Applicant: Pekka Parikka, Helsinki (FI)

(72) Inventor: Pekka Parikka, Helsinki (FI)

(21) Appl. No.: 18/514,610

(22) Filed: Nov. 20, 2023

(30) Foreign Application Priority Data
Sep. 27, 2023 (FI) 20236065

(51) Int. Cl. G08G 1/0968; G08G 1/005; G08G 1/09

(52) U.S. Cl. CPC G08G 1/096883; G08G 1/005; G08G 1/091

(57) ABSTRACT

A signal device for creating a signal produced by light in traffic, which signal device comprises a power source for creating power in the signal device. Further, the signal device comprises a light device for creating the signal produced by light. Further, the signal device comprises a position sensor for measuring the position or change in position of the signal device. Further, the signal device comprises a microcontroller for controlling the light device to produce the signal produced by light in determined positions or changes in position of the signal device measured by the position sensor, which microcontroller is connected to the power source, the light device and the position sensor. The signal device further comprises a device cabinet, wherein the power source, the light device, the position sensor, and the microcontroller are arranged.

### CROSS-REFERENCE TO RELATED PATENT APPLICATION

This application claims priority from Finnish Patent Application 20236065, filed Sep. 27, 2023, the entire contents of which is incorporated by reference herein as if expressly set forth in its respective entirety herein.

### BACKGROUND OF THE INVENTION

The inventions related to a signal device for creating a signal produced by light in traffic. Particularly, the invention relates to a signal device connectable to a user's hand.

Typically, a user, when e.g. walking or riding a bicycle, a scooter, an electric scooter, or a one-wheeled/two-wheeled vehicle with an electric motor and with or without handlebars, behaves in accordance with traffic regulations and gives a signal, such as e.g. a turning signal in crossroads. The user can be a user of bicycle and pedestrian traffic.

However, a problem with giving a signal, such as e.g. a turning signal, for the user is that the signal is not given and/or the other traffic does not easily observe the signal given by the user.

### BRIEF DESCRIPTION OF THE INVENTION

It is an object of the present invention to provide a new type of a signal device. The solution according to the invention is characterized by what is disclosed in the independent claims. Some embodiments of the invention are presented in the dependent claims.

In the presented solution, the signal device for creating a signal produced by light in traffic comprises a power source for creating power in the signal device. Further, the signal device comprises a light device for creating a signal produced by light. Further, the signal device comprises a position sensor for measuring the position of the signal device or its change. Further, the signal device comprises a microcontroller for controlling the light device to produce a signal produced by light in determined positions of the signal device measured by the position sensor or their changes, which microcontroller is connected to the power source, the light device and the position sensor. The signal device further comprises a device cabinet, wherein the power source, the light device, the position sensor, and the microcontroller are arranged.

According to an embodiment, the signal device comprises means, such as e.g. wristband, headband or strap, for connecting the signal device to the user's hand, wherein the position sensor is thus configured to measure the position or change in position of the signal device, and wherein the signal produced by the light of the light device is used for e.g. indicating a turn. When the signal device is secured in the user's hand, both the user's hand and the signal device show the signal, such as e.g. an indication of turning in traffic. Therefore, e.g. the turning indication is easy to observe in traffic both during daylight hours and during dark hours. This, the signal device connected to e.g. the hand can be positioned as far as possible from the user's body e.g. to the side or upwards, whereby the signal produced by light is easy to observe.

### BRIEF DESCRIPTION OF THE DRAWINGS

The invention will now be described in greater detail by means of preferred embodiments and with reference to the attached drawings, in which:

FIG. 1 is a schematic view of a signal device,

FIG. 2 is a schematic view of the signal device of FIG. 1 which further comprises sensors, a real-time clock, a memory, and a connecting route,

FIG. 3A is a schematic view of two signal devices of FIG. 2 connected to a user,

FIG. 3B is a schematic view of two signal devices of FIG. 2 connected to a user in a situation, in which, one of the signal devices creates a turning indication,

FIG. 4A is a schematic view of two signal devices of FIG. 2 connected to a user riding a bicycle,

FIG. 4B is a schematic view of two signal devices of FIG. 2 connected to a user riding a bicycle in a situation, in which, one of the signal devices creates a turning indication,

FIG. 5 is a schematic view of a signal device of FIG. 1 or 2 connectable to a user's hand, and

FIG. 6 is a schematic view of a signal device partially in accordance with FIG. 1 or 2 connectable to a user's hand.

### DETAILED DESCRIPTION OF THE INVENTION

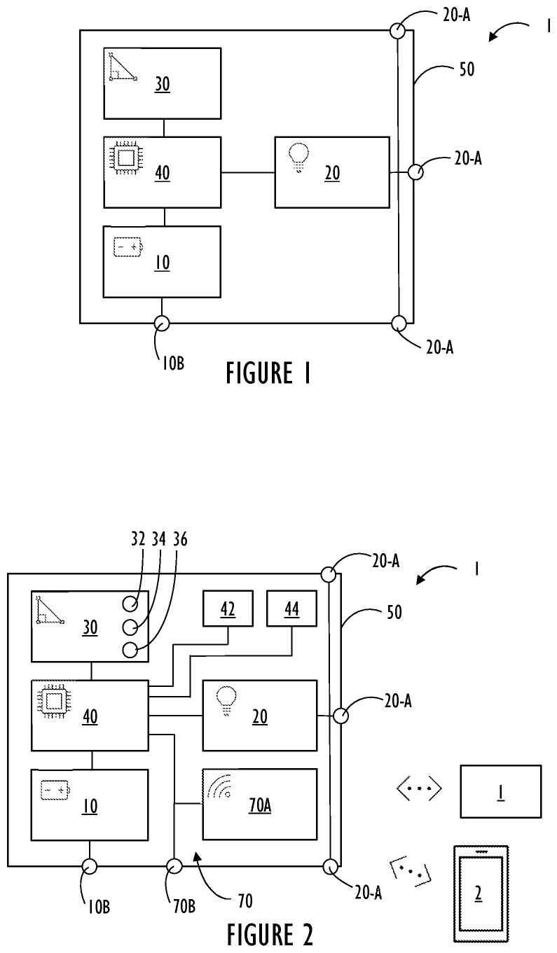

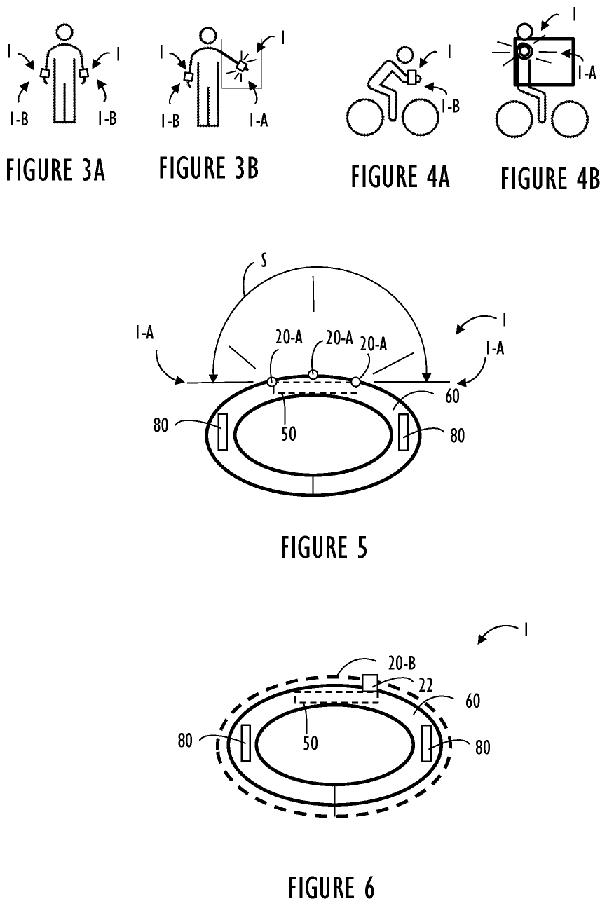

FIG. 1 is a schematic view of a signal device 1 which operates independently. FIG. 2 is a schematic view of the signal device of FIG. 1 which further comprises sensors, a real-time clock, a memory, and a connecting route, wherein the signal device 1 is connectable to other devices and a second signal device 1. FIG. 3A is a schematic view of two signal devices 1 of FIG. 2 connected to a user. FIG. 3B is a schematic view of two signal devices of FIG. 2 connected to a user in a situation, in which, one of the signal devices creates a turning indication. FIG. 4A is a schematic view of two signal devices of FIG. 2 connected to a user riding a bicycle. FIG. 4B is a schematic view of two signal devices of FIG. 2 connected to a user riding a bicycle in a situation, in which, one of the signal devices creates a turning indication. FIG. 5 is a schematic view of a signal device of FIG. 1 or 2 connectable to a user's hand.

The signal device of the figures is intended for creating a signal 1-A produced by light in traffic. In more detail, said traffic refers to (at least) a pedestrian and bicycle way, i.e. in other words, the signal device is intended for creating a signal 1-A produced by light (at least) on a pedestrian and bicycle way.

The signal device 1 for creating a signal 1-A produced by light in traffic of the figures comprises a power source 10 for creating power in the signal device 1. Further, the signal device comprises a light device 20 for creating a signal produced by light. Further, the signal device comprises a position sensor 30 for measuring the position or change in position of the signal device 1. Further, the signal device comprises a microcontroller 40 for controlling the light device 20 to produce a signal produced by light in determined positions of the signal device 1 measured by the position sensor 30 or their changes. Further, the microcontroller 40 is connected to a battery 10, the light device 20 and the position sensor 30. The signal device further comprises a device cabinet 50, wherein the power source 10, the light device 20, the position sensor 30, and the microcontroller 40 are arranged. The signal 1-A produced by light comprises a turning indiction, or in other words, the signal produced by the light of the light device 20 is used e.g. for indicating turning, wherein the signal produced by light flashes at a determined first frequency, a determined first intensity and a determined first colour. The signal 1-A produced by light comprises an other attention sign, or in other words, the signal produced by the light of the light device 20 cal additionally be used e.g. for indicating some other attention, wherein the signal produced by light flashes at a determined second frequency, a determined second intensity and a determined second colour. The signal 1-A produced by light is in other words an attention light 1-A or an operation light 1-A. The signal 1-A produced by light comprises a turning signal. The signal 1-A produced by light comprises a other attention signal.

The power source 10 for creating/producing energy in the signal device 1 of the figures is e.g. a (rechargeable) battery, a replaceable battery or some other equivalent power source. The power source 10 is the energy source for the operations of the light device 20, the position sensor 30 and the microcontroller 40. Furthermore, the power source 10 is the energy source for the operations of a connecting interface 70 to be described later, such as e.g. a transceiver 70A. Additionally, the power source 10 is the energy source for the operations of a real-time clock 42 to be described later. In addition, the power source 10 is the energy source for the operations of a memory 44 to be described later. In FIG. 2, the light device 20, the position sensor 30, the real-time clock 42, the memory 44, and the connection path 70 are in connection with the power source via the microcontroller 40, but it is still possible that some of the above components are alternatively or additionally connected directly to the power source 10.

The power source 10 of the figures is a (rechargeable) battery, to which is connected an inlet 10B for charging it by means of an external energy source, such as a mains current source. The inlet 10B can be e.g. an USB port or some other equivalent port. Said inlet 10B is in other words a port 10B.

The light device 20 of the figures is configured to produce/create the signal 1-A produced by light. The light device 20 creates light at a sector of at least 180 degrees for making the signal produced by light visible to the surroundings/in the traffic. The light device 20 comprises several LEDs 20-A for creating a signal produced by light. The LEDs 20-A of the light device 20 are configured to form a sector S for making the signal 1-A produced by light visible to the surroundings, which sector S is schematically illustrated in FIG. 5. Said sector S is at least 180 degrees. It should be taken into consideration that it is not necessary for the LEDs 20-A to be directed at an angle of 180 degrees in relation to each other for forming the sector S, but it is substantial that the light produced by the LEDs 20-A forms a sector of at least 180 degrees. The LEDs 20-A of the light device 20 can be directed such that the light produced by them forms a sector of 360 degrees. A sector created by light being as extensive as possible facilitates the visibility of light to the surroundings in several different positions of the user's hand. In the area of the sector S formed by the light of the LEDs 20-A, there can be blind spots where the light does not show. The light device 20 is connected via the microcontroller 40 to the battery 10 for creating required energy.

Furthermore, the light device 20 does not produce any light, or alternatively, the light 20 produces basic light 1-B when the light device 20 does not produce the signal 1-A produced by light, such as e.g. a turning signal or some other attention signal. The basic light 1-B refers to light not attracting so much attention as the signal produced by light. The basic light 1-B attracts less attention than the signal produced by light e.g. in the following ways: the basic light does not flash, the basic light flashes less frequently than the signal produced by light, the colour of the basic light is different from the colour of the signal produced by light, and/or the brightness of the basic light is dimmer than the brightness of the signal produced by light. Said basic light 1-B can refer to the light device 20 not producing light at all. It is obvious for those skilled in the art that the signal produced by light of the light device 20 must stand sufficiently out of the basic light 1-B in order for the signal 1-A produced by light attracts attention in traffic.

The position sensor 30 of the figures is configured to measure the position or change in position of the signal device 1, which position or change in position of the signal device is connected to the position of the user's hand or its change. The position sensor 30 is connected to the microcontroller 40 which processes the measurements of the position sensor 30. By means of the measurement of the position sensor 30, the position of the user's hand or the change in the hand's position is determined. For example, for showing a turning signal, the user typically lifts their hand on the side in relation to their body and keeps their hand at the side for a determined time. To signal for some other attention, the user can e.g. lift their hand up above their head. It should be noticed that the change or the speed of change in the hand's position can be sufficient to indicate when wishing to switch on the light device 20 for showing the signal produced by light.

The position sensor 30 of the signal device 1 comprises a sensor or sensors, such as e.g. an angle transducer 32, an acceleration sensor 34 and/or a rotation angle transducer 36 for determining the position or the change in position of the signal device 1.

The position sensor 30 of the signal device 1 of FIGS. 2-6 comprises at least one angle transducer 32 for measuring the angle or the change in angle of the signal device 1 in relation to a determined axis. The determined axis can be e.g. the gravitational axis. The determined axis can be a magnetic field or, in more detail, the determined axis can be an axis parallel with the magnetic field at the observation point. The determined axis can be e.g. a position of a second signal device connected to the signal device or, in more detail, the determined axis can be an angle measured by the angle transducer of a second signal device connected to the signal device. The determined axis can be determined e.g. from setting to be described later in more detail or the direction of the determined axis can vary depending on e.g. the user being a pedestrian, a cyclist or something equivalent. The measurements of the angle transducer 32 have a connection with the hand's position or change in position, based on which, the light device 20 is controlled to create the signal produced by light. The signal device 1 and the user's hand connected to it can be in their first position directed e.g. diagonally down or front and in their second position towards the side, wherein the change between the first position and the second position can be measured by measuring an angle, change in angle and/or speed of change.

Furthermore, the position sensor 30 comprises at least one acceleration sensor 34 for measuring the acceleration or change in acceleration of the signal device 1. The signal device 1 and the user's hand can be in their first position directed e.g. downwards or forward in relation to the user and in their second position towards the side, wherein the change between the first position and the second position can be measured by measuring the speed, acceleration or change in acceleration of the signal device 1.

The position sensor 30 further comprises at least one angle transducer/rotation angle transducer 36 for measuring the rotation angle or the change in rotation angle of the signal device 1 in relation to the determined axis. The signal device 1 and the user's hand can be in their first position at a specific rotation angle and in their second position at another rotation angle, wherein the change between the first position and the second position can be measured by measuring the rotation angle, change in rotation angle and/or speed of change. The angle transducer/rotation angle transducer 36 connected to the user's hand can measure e.g. a change in angle around a determined axis, which determined axis is parallel with the user's hand.

The microcontroller 40 of the figures controls the light device 20 to create a signal produced by light in determined positions of the signal device 1 or their changes. In more detail, the microcontroller 40 controls the light device 20 to create a signal produced by light in determined positions or changes in position measured by the position sensor 30 of the signal device 1. When the measurement of the position sensor does not correspond to the determined positions or changes in position of the signal device, the microcontroller 40 controls the light device 20 to a basic mode where the light device 20 does not produce light or where the light device 20 produces basic light 1-B.

The microcontroller 40 of FIGS. 2-6 is configured to control the light device 20 to create the signal produced by light based on the measurements of a sensor or sensors, such as e.g. the angle transducer 32, the acceleration sensor 34 and/or rotation angle transducer 36. The microcontroller 40 is configured to control the light device 20 to create the signal 1-A produced by light based on the measurements of at least one angle transducer 32. The microcontroller 40 is configured to control the light device 20 to create the signal 1-A produced by light based on the measurements of at least one acceleration sensor 34. The microcontroller 40 is configured to control the light device 20 to create the signal 1-A produced by light based on the measurements of at least one rotation angle transducer 36. The control of the light device 20 can be based on the measurement of e.g. one of the above sensors, such as the angle measured by the angle transducer in relation to the determined axis or e.g. the angle measured by the angle transducer in relation to the determined axis or the change in angle of the same measured angle. The control of the light device 20 can be based on the measurement of many measurements of the above sensors, such as the angle measured by the angle transducer in relation to the gravitational axis and the acceleration measured by the acceleration sensor or e.g. the angle measured by the angle transducer in relation to the determined axis and the change in angle measured by the rotation angle transducer.

The power source 10, the light device 20, the position sensor 30, and the microcontroller 40 are arranged to the device cabinet 50 of the figures. The device cabinet 50 is an enclosure manufactured of e.g. plastic and/or metal, to which, the components of the signal device 1 are arranged. Furthermore, the inlet 10-B of the power source 10 is arranged to the device cabinet 50. Additionally, the real-time clock 42 to be described later is arranged to the device cabinet 50. In addition, the memory 44 to be described later is arranged to the device cabinet 50. The connection path 70 to be described later is further arranged to the device cabinet. A transceiver 70-A of the connection path 70 to be described later is additionally arranged to the device cabinet 50. In addition, an inlet 70-B of the connection path 70 to be described later is arranged to the device cabinet 50. The device cabinet 50 protects the components of the signal device 1 from e.g. heat, sunshine, moisture and/or water.

The signal device 1 of the figures comprises means 60 for connecting the signal device 1 to the user's hand. Said means 60 can be e.g. connected to the device cabinet 50 or, alternatively, said means 60 can be integrated to the device cabinet 50. Said means 60 comprise e.g. a wristband, a headband or a strap. Said means 60 are manufactured of e.g. metal, plastic and/or rubber-based mixture. Said means 60 help the signal device to be easy to use for the user. When the signal device is secured to the user's hand, the position or the change in position of the signal device has a connection with the position or change in position of the user's hand. The position sensor 30 is thus configured to measure the position or change in position of the signal device 1, which position or change in position of the signal device is connected to the position or change in position of the user's hand. The signal produced by the light of the light device 20 is used at least for showing a turning signal, wherein the turning signal is easy to observe because the user's hand shows the turning signal which is enhanced by the light created by the light device. It should be mentioned for clarity that the signal device can be connected by said means directly to the hand or on top of layers of clothing, such as e.g. a coat, being on top of the hand.

Furthermore, the means 60 for connecting the signal device 1 to the user's hand comprise reflective material for the visibility of the signal device in traffic. Particularly, the reflective material helps in a situation where the light device of the signal device 1 does not produce any light.

The signal device 1 of FIGS. 2-6 comprises a connection path 70 for forming a connection to a second signal device 1 and/or a smart phone 2. Via the connection path 70, the (first) signal device 1 can be connected to e.g. the second signal device 1, whereby the signal devices 1 connected to each other can share the data on their position or change in position with each other. Via the connection path 70, the signal device can be connected to e.g. a smart phone 2, via which, it is possible to adjust the settings, such as basic settings or advanced settings, of the signal device, which will be described later in more detail. The connection path 70 is connected to the microcontroller 40. The connection path 70 comprises a transceiver 70A for forming a wireless connection. The connection path 70 comprises an inlet 70B for forming a connection via a cable. Said inlet 70B of the connection path 70 and the inlet 10B of the power source 10 can be integrated as the same inlet. The connection path 70 is in other words a connection interface 70.

The microcontroller 40 of the (first) signal device 1 of FIGS. 2-6 is configured to receive via the connection path 70 the position or change in position of the second signal device 1. In more detail, the microcontroller 40 of the signal device 1 is configured to receive via the transceiver 70-A the position or change in position of the second signal device 1 measured by the position sensor 30 of the second signal device 1. The microcontroller 40 of the (first) signal device 1 is configured to compare the position or change in position of the signal device 1 with the position or change in position of the received second signal device. Additionally, the microcontroller 40 is configured for controlling the light device 20 to produce a signal 1-A produced by light when the position or change in position of the signal device 1 differs determinedly from the position or change in position of the second signal device. In other words, the microcontroller 40 of the (first) signal device 1 is configured for controlling the light device 20 to produce a signal 1-A produced by light based on the difference/offset of the position or change in position of the first signal device and the position or change in position of the second signal device. Thus, it is possible to determine based on the difference of the positions and changes in position of the first signal device 1 and the second signal device 1 connected to it when the first signal device 1 creates the signal 1-A produced by light of the basic light 1-B, and when the second signal device 1 creates the signal 1-A produced by light or the basic light 1-B.

The signal device 1 of FIGS. 2-6 comprises a real-time clock 42 connected to the microcontroller 40. The real-time clock 42 is configured to measure time. The real-time clock 42 is configured to measure the speed of change of the position or change in position of the signal device 1, based on which, the microcontroller 40 controls the light device 20 to create the signal produced by light. The real-time clock 42 can be directly integrated to the microcontroller 40.

Furthermore, the real-time clock 42 can help to control the on time of the signal produced by light. The microcontroller 40 is configured to control the light device to create the signal 1-A produced by light for a determined time based on the time measured by the real-time clock 42.

The signal device 1 of FIGS. 2-6 comprises a memory 44 connected to the microcontroller 40. Adjustable basic settings are stored in the memory 44, which basic setting comprise those positions or changes in position of the signal device 1, based on which, the microcontroller 40 controls the light device 20 to create the signal produced by light. Said basic settings can be adjusted via the connection path 70 e.g. by means of the smart phone 2. The memory 44 can be directly integrated to the microcontroller 40.

Furthermore, it is possible to adjust the basic settings e.g. for how long the signal produced by light created by the light device 20 is on. The microcontroller 40 is configured to control the light device 20 to create the signal produced by light for a determined time. Said specific time can be e.g. x seconds (x=1, 2, 3 . . . ). Time counting can be started e.g. when the signal device arrives to a determined position or change in position where the creation of the signal produced by light is started. The time counting can be started from e.g. when the signal device leaves from the determined position. The time counting is implemented by the above-mentioned real-time clock 42.

Furthermore, it is possible to adjust the basic settings e.g. of turning the signal off based on the position or change in position of the signal device. The user can turn the signal produced by light off e.g. by a specific motion or combination of motions when though the signal device is in the determined position for creating the signal produced by light. Said determined motion can be e.g. the hand's rotational motion to-and-fro or the hand's wave into determined directions in a specific order. For example, the angle transducer or the rotation angle transducer can measure the hand's rotational motion. For example, the acceleration sensor can measure the hand's wave.

Furthermore, adjustable advanced settings are stored in the memory 44, which advanced settings comprise the colour, frequency and/or brightness of the signal produced by light created by the light device 20. In order to form a turning signal, the signal produced by light can be e.g. an orange light flashing at a determined frequency and brightness. In order to form another attention signal, the signal produced by light can be e.g. red of its colour, which burn red continuously or which flashes red at a determined frequency.

The smart phone 2 of FIGS. 2-6 is configured to be connected to the signal device 1. The smart phone 2 comprises a programme for adjusting the basic settings and/or the advanced setting of the signal device. Said programme can be e.g. as follows. For adjusting the basic settings, the programme asks the user to set their hands to the first position or positions for a determined time, whereby the programme stores the measurements and changes in measurements of the sensors of the position sensor 30 to the memory 44 of the signal device 1. Furthermore, the programme asks the user to set their hands to the second position or positions for a determined time in order to show e.g. a turning signal, whereby the programme stores the measurements and changes in measurements of the sensors of the position sensor 30 in relation to the first position to the memory 44 of the signal device 1. Additionally, the programme can asks the user to set their hands to the third position or positions for a determined time in order to show e.g. another attention signal, whereby the programme stores the measurements and changes in measurements of the sensors of the position sensor 30 in relation to the first position to the memory 44 of the signal device 1. Several basic settings can be stored to the programme, the first of which is intended e.g. for walking, the second is intended for cycling and the third is intended for riding a two-wheeled vehicle without handlebars. In order to adjust advanced settings, such as e.g. adjusting the colour, intensity or frequency of the light being created, the programme can comprise menu or adjustment bar solutions which are obvious to those skilled in the art and which can be shown on the display of the smart phone 2.

Next, a method for showing a signal produced by light in traffic by using a signal device will be described. In the method, the signal device is configured to be secured to the user's hand, wherein the signal produced by light by the light device is a turning signal. In the method, the position or change in position of the signal device is measured. In the method, the position or change in position of the signal device measured by the position sensor of the microcontroller is compared with determined positions or changes in position of the signal device. In the method, a signal produced by light is created by the light device when the position or change in position of the signal device is in a determined area.

Furthermore, some more details related to the method are as follows. In the method, a position sensor measures the angle or change in angle of the signal device in relation to a determined axis. In the method, a microcontroller compares the measured angle or change in angle with determined angles or changes in angles. In the method, a signal produced by light is created by a light device when the angle or change in angle of the signal device is in a determined area.

Furthermore, some more details related to the method are as follows. In the method, a position sensor measures the acceleration or change in acceleration of the signal device in relation to a determined axis. In the method, the microcontroller compares the measured acceleration or change in acceleration with determined accelerations or changes in acceleration. In the method, a signal produced by light is created by the light device when the acceleration or change in acceleration of the signal device is in a determined area.

Furthermore, some more details related to the method are as follows. In the method, the signal device is connected to a second signal device for receiving its position or change in position. In the method, the determined area for the positions or changes in position of the signal device for creating a signal produced by light is determined in relation to the positions or changes in position of a second signal device.

FIG. 6 is a schematic view of a signal device of FIG. 1 or 2 connectable to a user's hand, wherein the light device 20 comprises a display 20-B instead of LEDs 20-A. The light device 20 of the signal device 1 comprises a display 20-B which is designated by dashed lines in the figure for clarity. Said display 20-B can be an alternative solution instead of said LEDs 20-A of the light device 20 for creating a signal produced by light or the light device 20 can comprise said display 20-B in addition to the LEDs 20-A. Said display 20-B can be a touch screen and thus enable the adjustment of various functions, such as the above basic settings and/or advanced settings. The display 20-B can surround the signal device 1 partially, or the display 20-B can surround the signal device 1 totally. The signal device 1 can be a smart tracker or a smart watch, wherein the smart tracker comprises a display and wherein the display is used for creating the signal produced by light. It should be taken into consideration that the display 20-B must be such that it can create a light signal attracting sufficient attention in traffic.

The signal device 1 of FIG. 6 itself includes a user interface which is shown via the display 20-B. The user interface can be controlled e.g. via the display 20-B, the display being a touch screen. The signal device 1 comprises at least one button 22 for controlling the user interface but it should be noticed that the button 22 is not necessary e.g. in a situation where the display 20-B is a touch screen. Said button 22 is a part of the device cabinet 50 of the signal device 1. Said button 22 is connected to the microcontroller 40.

The signal device 1 of FIGS. 5 and 6 comprises fasteners 80 for keeping the signal device 1 temporarily fast to a second signal device. The fasteners 80 of the first signal device can be e.g. magnets corresponding to the fasteners 80 of the second signal device being e.g. magnets. The fasteners 80 of the first signal device can be e.g. releasable mode locks corresponding to the fasteners 80 of the second signal device being e.g. a releasable mode lock. The signal device 1 can be kept fast to the second signal device for e.g. storage. The signal device 1 can be kept fast to the second signal device and then connect them as a pair to the user's hand, whereby the signal device pair is easy to transport in one hand. Furthermore, the second signal device is easy to release from the first signal device and to connect the second signal device to the user's other hand, whereby the signal device can be used in traffic e.g. to show a turning signal with either hand.

Additionally, the signal device of FIGS. 5 and 6 can comprise a sensor configured to identify that the signal device is fast to the second signal device. When fast to each other, the first signal device and the second signal device are configured to send the signal produced by light burning at determined (third) intensity and (third) colour. When said signal devices are fast to each other, they can be programmed such that they do not create e.g. a turning signal or some other attention signal.

According to an example, the user uses the signal device when walking in traffic, such as schematically illustrated e.g. in FIGS. 3A and 3B. In more detail, the user has a signal device 1 in both hands. When walking, the user keeps their hands in a first position diagonally down. For showing a turning signal, the user lifts one hand towards the side, whereby the signal device is towards the side e.g. in relation to the gravitational axis, or when the signal device is at an angle in relation to e.g. the second signal device, the angle being e.g. about 90 degrees.

According to a second example, the user uses the signal device when cycling in traffic, such as schematically illustrated e.g. in FIGS. 4A and 4B. In more detail, the user has a signal device 1 in both hands. When cycling, the user keeps their hands in a first position on the handlebars, whereby they are directed forward in relation to the user. For showing a turning signal, the user lifts one hand towards the side, whereby the signal device is at an angle in relation to e.g. the second signal device, the angle being e.g. about 90 degrees.

According to a third example, the user uses the signal device when guiding a two-wheeled vehicle without handlebars in traffic. In more detail, the user has a signal device 1 in both hands. The two-wheeled vehicle without handlebars comprises a motor and other means for guiding it e.g. based on centre of gravity. When guiding said vehicle, the user keeps their hands in a first position diagonally down. For showing a turning signal, the user lifts one hand towards the side, whereby the signal device is towards the side e.g. in relation to the gravitational axis, or when the signal device is at an angle in relation to e.g. the second signal device, the angle being e.g. about 90 degrees.

According to a fourth example, the user uses the signal device when guiding a two-wheeled vehicle with handlebars in traffic. The two-wheeled vehicle with handlebars comprises a motor and other means for guiding it by the handlebars or based on centre of gravity. The two-wheeled vehicle with handlebars can be e.g. an (electric) scooter. When guiding said vehicle, the user keeps their hands in a first position on the handlebars, whereby they are directed forward in relation to the user. For showing a turning signal, the user lifts one hand towards the side, whereby the signal device is at an angle in relation to e.g. the second signal device, the angle being e.g. about 90 degrees.

It was mentioned above that the signal device 1 comprises a position sensor 30 for measuring the position or change in position of the signal device 1. The signal device 1 can comprise a position sensor for measuring the position of the signal device 1. The signal device 1 can comprise a position sensor for measuring the change in position of the signal device 1. Respectively related to the microcontroller 40, the signal device 1 can comprise a microcontroller 40 for controlling the light device 20 to create a signal 1-A produced by light in determined positions of the signal device 1 measured by the position sensor 30. The signal device 1 can comprise a microcontroller 40 for controlling the light device 20 to create a signal 1-A produced by light in determined changes of position of the signal device 1 measured by the position sensor 30.

Those skilled in the art will find it obvious that, as technology advances, the basic idea of the invention may be implemented in many different ways. The invention and its embodiments are thus not restricted to the above-described examples but may vary within the scope of the claims.

1. A signal device for creating a signal produced by light in traffic, wherein the signal device comprises
a power source for creating energy in the signal device,
a light device for creating the signal produced by light,
a position sensor for measuring the position or change in position of the signal device,
a microcontroller for controlling the light device to create the signal produced by light in determined positions or changes in position of the signal device measured by the position sensor, which microcontroller is connected to the power source, the light device and the position sensor, and
a device cabinet, wherein the power source, the light device, the position sensor, and the microcontroller are arranged.

2. A signal device according to claim 1, wherein the signal device comprises means, such as a wristband, a headband or a strap, for connecting the signal device to a user's hand, and wherein
the position sensor is thereby configured to measure the position or change in position of the signal device, corresponding the position or change in position of the user's hand.

3. A signal device according to claim 2, wherein the signal produced by light comprises at least a turning signal.

4. A signal device according to claim 2, wherein the position sensor comprises at least one angle transducer for measuring the angle or the change in angle of the signal device in relation to a determined axis, and wherein
the microcontroller is configured to control the light device to create the signal produced by light based on the measurements of at least one angle transducer.

5. A signal device according to claim 1, wherein the position sensor comprises at least one acceleration sensor for measuring the acceleration or change in acceleration of the signal device, and wherein
the microcontroller is configured to control the light device to create the signal produced by light based on the measurements of at least one acceleration sensor.

6. A signal device according to claim 1, wherein the signal device further comprises
a connection path for forming a connection to a second signal device for receiving a measurement related to its position or change in position, which connection path comprises a transceiver connected to the microcontroller, and wherein
the microcontroller is configured to compare the position or change in position of the signal device with the position or change in position of the received second signal device, wherein the microcontroller is further configured to control the light device to create the signal produced by light when the position or change in position of the signal device differs determinately from the position or change in position of the second signal device.

7. A signal device according to claim 1, wherein the signal device further comprises
a connection path for forming a connection to a smart phone, which connection path comprises a transceiver connected to the microcontroller, and wherein
the determined positions or changes in position of the signal device for switching the light device to create the signal produced by light are adjustable via the smart phone.

8. A signal device according to claim 1, wherein the signal device further comprises a real-time clock connected to the microcontroller, which real-time clock is configured to measure the speed of change of the position or change in position of the signal device, based on which, the microcontroller controls the light device to create a signal produced by light.

9. A signal device according to claim 1, wherein the signal device additionally comprises a memory connected to the microcontroller, to which memory are stored basic settings comprising the positions and changes in position of the signal device, based on which, the microcontroller controls the light device to create the signal produced by light.

10. A signal device according to claim 9, wherein to the memory of the signal device are stored adjustable advanced settings comprising the colour, frequency and/or brightness of the signal produced by light of the light device.

11. A signal device according to claim 1, wherein the light device comprises several LEDs for creating the signal produced by light.

12. A signal device according to claim 11, wherein, in the signal device, the LEDs of the light device are configured to form a sector for making the signal produced by light visible to the surroundings, which sector is at least 180 degrees.

13. A method for creating a signal produced by light in traffic by a signal device, in which method
measuring by a position sensor a position or change in position of the signal device,
comparing by a microcontroller the position or change in position of the signal device measured by the position sensor with determined positions or changes in position of the signal device, and
creating by a light device the signal produced by light when the position or change in position of the signal device measured by the position sensor is in a determined area.

14. A method according to claim 13, wherein the signal device is configured to be fastened to the user's hand, and wherein the signal produced by light of the light device is a turning signal.

15. A method according to claim 14, wherein
the position sensor measures the angle or change in angle of the signal device in relation to a determined axis,
the microcontroller compares the measured angle or change in angle with determined angles or changes in angles, and wherein
the light device creates the signal produced by light when the measured angle or change in angle of the signal device is in a determined area.

16. A method according to claim 14, wherein
the position sensor measures the acceleration or change in acceleration of the signal device in relation to a determined axis,
the microcontroller compares the measured acceleration or change in acceleration of the signal device with determined accelerations or changes in acceleration, and wherein
the light device creates the signal produced by light when the measured acceleration or change in acceleration of the signal device is in a determined area.

17. A method according to claim 14, wherein the signal device is connected to a second signal device for receiving the measurement of its position or change in position, wherein
the determined area for the positions or changes in position of the signal device for creating the signal produced by light is determined in relation to the positions or changes in position of the second signal device.

18. A smart clock to which is integrated a signal device according to claim 3, wherein the light device of the signal device is a display or comprises a display.
